(19) United States
(12) Patent Application Publication
(10) Pub. No.: US 2020/0366797 A1
(43) Pub. Date: Nov. 19, 2020

(54) DEVICES AND METHODS FOR SHARING AND DISPLAYING IMAGES

(71) Applicant: ASWESHARE, Bois Guillaume (FR)

(72) Inventor: Alexis LE GOFF, Bois Guillaume (FR)

(73) Assignee: ASWESHARE, Bois Guillaume (FR)

(21) Appl. No.: 16/763,789

(22) PCT Filed: Nov. 14, 2018
(86) PCT No.: PCT/EP2018/081275

§ 371 Date: Jul. 28, 2020

(30) Foreign Application Priority Data
Nov. 14, 2017 (FR) 1760667

(51) Int. Cl. H04N 1/00; H04L 12/46; H04L 29/08

(52) U.S. Cl. CPC H04N 1/00106; H04L 67/12; H04L 12/4641

(57) ABSTRACT

An image-sharing system having: an interface designed to receive an image display request containing a display address and an image; a data storage module storing static IP addresses associated with a plurality of display devices in a virtual private network; and a module for providing images, which is designed to determine that the display address corresponds to a static IP address, to transmit the image to an image storage server, to receive a reception message comprising an image storage address, and to transmit an information message containing the storage address of the image to the static IP address associated with the target display device. An image display device and to methods for sharing and displaying images is also disclosed.

### TECHNICAL FIELD

The invention relates to the field of sharing images via a digital communication network, in particular to image-sharing servers, image display devices and image-sharing and image-displaying methods. Technological Background

Document WO02/09415 teaches a method for displaying photos on connected photo frames in communication networks such as the Internet or a cellular network.

The connected photo frames update themselves by polling a photo-sharing server at regular intervals in order to check for the presence of new photos. As such, data usage is high between the connected photo frame and the photo-sharing server due to the periodic requests. Additionally, data usage could be decreased only at the cost of a long latency period between the photo-sharing server receiving a new photo and the new photo being displayed by the connected photo frame, in particular due to the interval between two update requests.

Document US20100013918 teaches a method for exchanging images between a static server, cameras and a telephone. Bidirectionality of communications is ensured by the central server which has a static public IP address.

The cameras are connected by virtue of a persistent “keep-alive” connection for bidirectionality of communications. For this type of connection, communications have to be performed to keep the link open beyond the transmission of images and it is therefore too costly for M2M (machine-to-machine) exchanges in a private or leisure context. Specifically, the principle of “keep-alive” is based on the server regularly checking the status of the TCP/IP connections.

### SUMMARY

The invention makes it possible to address the need to be able to send photos instantaneously and at low cost to photo frames connected to a digital communication network.

These actions of sending photos in a private and leisure context by means of machine-to-machine protocols must be able to be performed without high costs being incurred due to the data exchanges and must use networks which ensure confidentiality.

To satisfy the requirement for confidentiality, the invention allows the display devices to be addressed via an IP-layer virtual private network.

In the invention, the connected objects are closed systems that are addressable via the network but not from outside the network, which makes it possible to cut down on data because there is no need to encrypt said data and hence the computing power of the connected object may be lower.

By using this type of protocol there is no need for securing on the side of the connected object, hence no need for encryption and the volume of the exchanged data may be decreased. This also makes it possible to use connected objects which do not necessarily possess substantial computing power.

To keep cost compatible with a leisure activity, the invention uses communication systems which open only at the moment of communication, such as SIM (subscriber identity module) cards (machine-to-machine (M2M) SIM cards), the memory of which includes an IMSI (international mobile subscriber identity) subscriber number associated with a static IP address for the display device.

Embedded SIMs (eSIMs), which are reprogrammable chips embedded in the equipment (connected objects) in the same way as the other electronic components, can also be used. Embedded SIMs allow the equipment to be set up and data to be updated remotely in just a few clicks.

The invention allows communications to be established between an image-sharing server, an image storage server and a plurality of display devices on a virtual private network.

In one embodiment, the invention provides an image-sharing system for allowing images to be transferred quickly and reliably between a source device and a target display device by means of an image-sharing server, of an image storage server and of a virtual private network.

To this end, the invention provides an image-sharing server including:
a receiver interface configured to receive, from a source device, an image display request including a display address and an image,
a data storage module storing a directory of display devices, said directory including static IP addresses in a virtual private network, said static IP addresses being respectively associated with a plurality of display devices,
a module for providing images, characterized in that it is an addressable closed system configured to, in response to receiving the image display request:
   determine whether the display address corresponds to a static IP address present in the directory of display devices and associated with a target display device,
   transmit, to an image storage server, a storage request including the image,
   receive, from the image storage server, a receipt message, the receipt message including a storage address for the image in the image storage server, and
   through the virtual private network, transmit, to the static IP address associated with the target display device, an information message including the storage address for the image.

Such a server may also include one or more of the following features.

In one embodiment, the information message is transmitted in response to receiving said receipt message.

In one embodiment, the directory of display devices includes associations between the display addresses and the static IP addresses. The associations between the display addresses and the static IP addresses may be made in various ways.

In one embodiment, the directory of display devices includes an entry for each display device; said entry includes a display address and a static IP address associated with the display device.

In one embodiment, the directory of display devices includes an entry for each display device, said entry including a display device identifier and a static IP address associated with the display device, and the display device identifier is associated through encoding with a display address. In this case, the image-sharing server may include a decoder module configured to decode the display address received in the image display request in order to find a display device identifier in the directory of display devices.

By virtue of such encoding, knowing a display address does not make it possible to easily infer the display addresses of other display devices.

In one embodiment, the display device identifier is a serial number of the display device, for example an IMEI number of a GSM/UMTS chip.

In one embodiment, the storage address for the image is a URL (uniform resource locator).

In one embodiment, the image-sharing server further includes an image-processing module configured to process the image received in the image display request so as to generate a reprocessed image, the image sent by the image-sharing server to the image storage server being the reprocessed image.

Such an image-processing module may apply various types of processing. In one embodiment, the directory of display devices further includes screen size settings of the display device, and the image-processing module is configured to apply, to the image, processing for resizing according to the screen size settings.

In one embodiment, the image-processing module is configured to apply, to the image, processing for compression. By virtue of these features, it is possible to limit data usage, for example to a level below 500 KB, in particular around 200 KB, per photo sent.

The image storage server and the image-sharing server may be implemented on the same platform or on different platforms. In the latter case, they communicate with one another via the virtual private network and each have a static IP address.

In one embodiment, the module for providing images is further configured to, in response to receiving the image display request, generate an image identifier associated with the image and save the image identifier in a subscriber account of an originating subscriber.

In one embodiment, the image-sharing server further includes a subscriber account management module for managing a directory of subscribers. The directory of subscribers, which may be stored in the data storage module of the image-sharing server, contains information on a set of originating subscribers, for example, for each originating subscriber, contact information for originating subscribers allowing a response message to be addressed to an originating subscriber. This directory of subscribers may also be used to save a history of display requests from an originating subscriber.

In one embodiment, the image-sharing server further includes a response-handling module configured to:
receive a response message, the response message including an image identifier or an originating subscriber identifier,
determine, using the subscriber directory, whether the image identifier or the originating subscriber identifier is associated with contact information for an originating subscriber,
perform a response information action according to the contact information for the originating subscriber.

The contact information may include an address for the source device in a communication network and/or an email address and/or a telephone number and/or another identifier of the originating subscriber. A number of different response information actions may be implemented. For example, the response information action is the transmission, by the image-sharing server, of a push notification to the source device. For example, the response information action is the sending of an email to the email address.

In such a directory of subscribers, the subscriber account of an originating subscriber may include associations between the contact information for the originating subscriber and one or more display addresses to which the originating subscriber wishes to be able to easily send display requests. Optionally, the subscriber account may further include an association between a display address and a personalized name of the display device. For example, the personalized name of the display device is a name or nickname that the originating subscriber assigns to the recipient user who uses the target display device.

In one embodiment, the display address is a first display address and the static IP address is a first static IP address, the target display device is a first target display device, the image display request further including a second display address, the module for providing images being further configured to, in response to receiving the transmission message,
determine whether the second display address corresponds to a second static IP address present in the directory of display devices and associated with a second target display device,
through the virtual private network, transmit, to the address associated with the second target display device, the information message including the storage address for the image.

The source device preferably includes a user interface including functionalities for creating the display request. This user interface may be implemented in various ways. In one embodiment, the image storage server may include an HTTP server to generate a web page providing a form for creating the display request.

According to some embodiments, the invention also provides a display device including:
a non-volatile memory storing an IMSI identifier corresponding to a static IP address configured to belong to a virtual private network,
an image storage module configured to store images,
a screen configured to display the images stored in the image storage module,
an image-loading module configured to:
   receive, from an image-sharing server through the virtual private network, an information message including a storage address for a new image in an image storage server,
   send a load request destined for the image storage server through the virtual private network in response to receiving the information message, the load request including the address for the new image,
   receive the new image from the image storage server through the virtual private network,
   store the new image in the image storage module.

Such a display device may include one or more of the following features.

The display device may be implemented in a great variety of ways, in particular by a cellular telephone, by a computer, by a tablet computer, etc. In one preferred embodiment, the display device is a connected digital photo frame, the functionalities of which may be very limited in number with a view to ensuring great ease of use.

In one embodiment, the display device further includes a cellular communication module for communicating with the image-sharing server via a cellular network.

In one embodiment, the display device further includes an M2M SIM (machine-to-machine subscriber identity module) card, the memory of which includes said IMSI identifier corresponding to the static IP address of the display device. The IMSI (international mobile subscriber identity) identifier is an identifier of the SIM card.

By virtue of the use of a SIM card, the image display device may receive and display images via the cellular network. Thus, the image display device may receive and display images even if there is no persistent open connection with the image-sharing server.

In one embodiment, the image-loading module is configured to, in response to receiving the new image, immediately display the new image on the screen.

In one embodiment, the display device further includes a response interface configured to, in response to an action by a recipient user on the display device, send a response message to the image-sharing server, the response message including an identifier of an image with which the response is associated or an originating subscriber identifier with which the response is associated.

The virtual private network may be implemented in a number of ways. In one embodiment, the virtual private network is implemented by an IP-layer technology, for example IPsec. Additionally, the virtual private network may be supported by any physical network, for example a physical network which may include wired or wireless implementation. Preferably, the frame includes a cellular network interface and the virtual private network is implemented at least partly on a cellular access network. Any cellular network technology may be used, in particular the GSM, GPRS, EDGE, UMTS, HSDPA, HSUPA, HSPA+, 3G, 4G or LTE technologies.

The images may be any type of image in any type of format. For example, the images are digital photographs. For example, the format of the images is selected from the list consisting of: Joint Photographic Experts Group (JPEG), Portable Network Graphics (PNG), Graphics Interchange Format (GIF), Windows bitmap (BMP), Tag Image File Format (TIFF), Portable Document Format (PDF).

According to some embodiments, the invention also provides an image-sharing method including:
receiving, from a source device, an image display request including a display address and an image,
determining whether the display address is associated with a target display device,
transmitting, to an image storage server, a storage request including the image,
receiving, from the image storage server, a receipt message, the receipt message including a storage address for the image in the image storage server, and
through a virtual private network, transmitting, to a static IP address associated with the target display device, an information message including the storage address for the image.

According to some embodiments, the invention also provides an image-displaying method, which may be implemented by a connected photo frame or another display device, including:
receiving, at a static IP address configured to belong to a virtual private network, from an image-sharing server through the virtual private network, an information message including a storage address for a new image in an image storage server,
sending a load request destined for the image storage server through the virtual private network in response to receiving the information message, the load request including the address for the new image,
receiving the new image from the image storage server through the virtual private network, and
storing the new image in an image storage module and/or displaying the new image on a screen.

### BRIEF DESCRIPTION OF THE FIGURES

The invention will be understood better and further aims, details, features and advantages thereof will become more clearly apparent from the following description of a number of particular embodiments of the invention, which are given solely by way of illustration and without limitation, with reference to the appended drawings.

FIG. 1 is a block diagram of an image-sharing system including an image-sharing server, an image storage server and an image display device which are connected via a virtual private network.

FIG. 2 is a call diagram which may be implemented in the image-sharing system of FIG. 1 in order to display a new image on the display device.

FIG. 3 is a block diagram of a method which may be implemented by the image-sharing server in order to find an address for the display device.

FIG. 4 is a schematic representation of an image that may be shared in the image-sharing system of FIG. 1.

FIG. 5 is a schematic representation of a screen of a connected photo frame that may be used in the image-sharing system of FIG. 1.

FIG. 6 is a schematic representation of the image of FIG. 4 reprocessed and displayed on the screen of FIG. 5.

FIG. 7 is a call diagram which may be implemented in the image-sharing system of FIG. 1 when the connected photo frame is activated.

FIG. 8 is a call diagram which may be implemented in the image-sharing system of FIG. 1 when the connected photo frame is registered with the image-sharing server.

FIG. 9 is an exemplary document provided with the connected frame stating its display address so that sending subscribers may display photos on the connected frame.

FIG. 10 is a symbolic representation of an image-sharing system similar to that of FIG. 1, including a plurality of source devices and a plurality of connected display devices.

FIG. 11 is a call diagram which may be implemented in the image-sharing system of FIG. 1 when the connected display device transmits a response to a source device.

### DETAILED DESCRIPTION OF EMBODIMENTS

Described below are methods and systems allowing an image to be displayed that an originating subscriber wishes to display on a display device, which will be referred to hereinafter as a “connected photo frame”, belonging to a recipient user. These methods and systems are particularly advantageous in that they allow the connected photo frame to have maximum simplicity and ease of use, which makes it suitable for any recipient user, including elderly people, young children or mentally disabled people. These display means thus promote social connections, for example intergenerational connections.

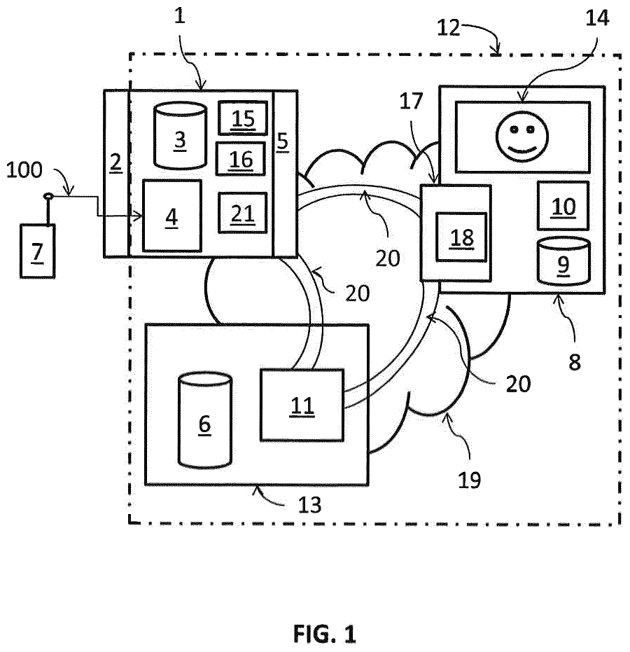

An image-sharing system is described with reference, but without being limited, to the example shown in FIG. 1.

The image-sharing device of FIG. 1 includes a source device 7 and a connected photo frame 8. The source device 7 allows an originating subscriber to send a new image to be displayed on the connected photo frame 8. The image-sharing system of FIG. 1 includes an image-sharing server 1, an image storage server 13 and a digital communication network 19 supporting a virtual private network 10 12. The digital communication network 19 includes at least one cellular radio access network. The digital communication network 19 is for example a telecommunications operators network.

FIG. 1 symbolically shows that the image-sharing server 1, the image storage server 13 and the connected photo frame 8 belong to the same virtual private network 12, which means that their communication goes through tunnels 20. The tunnels 20 are machine-to-machine communication channels that are encrypted in order to ensure the confidentiality and security of communications between the elements of the virtual private network 12. For example, this encryption is implemented using public and private keys.

Preferably, the virtual private network 12 is implemented by static IP addresses and all communications in the virtual private network 12 are implemented on a TCP/IP or HTTP/TCP/IP protocol stack. A static IP address is a unique and temporally and spatially fixed IP address. In particular, the image-sharing server 1 and the image storage server 13 each have a private static IP address, and the connected photo frame 8 also has a private static IP address. Thus, advantageously, the IP address of the connected photo frame 8 stays the same regardless of where the connected photo frame 8 is in the world at any given time, and in particular regardless of the network operator managing the cellular radio access network via which the frame is connected. Preferably, the private static IP address is uniquely 30 associated with an M2M SIM card. In the procedure of connecting the display device to the cellular radio access network, the cellular radio access network is configured to assign the private static IP address according to the IMSI subscriber number held in the memory of an M2M SIM card.

The tunnels use a cryptography technology employing a system of public keys and private keys. For example, the technology used is technology such as SSL and IPsec. The virtual private network 12, namely the encrypted tunnels 20, allows the network elements to be connected as if they belonged to a single dedicated network.

To display a new image, for example a digital photo, on the connected photo frame 8, a source device 7 sends an image display request 100 to the image-sharing server 1.

The image display request 100 is received via a receiver interface 2 of the image-sharing server 1.

The image-sharing server 1 includes a plurality of data-processing modules in order to allow the new image to be displayed on the connected photo frame 8.

The image-sharing server 1 includes in particular a module for providing images 4 capable of transmitting, to a target display device, an information message 103 including a storage address for the image.

The image-sharing server 1 also includes a data storage module 3 in which a directory of display devices is stored. The directory of display devices contains an entry table in which for example static IP addresses of connected photo frames and IMEI codes are recorded.

For originating subscribers, each connected photo frame is known by its display address. The display addresses are communicated to the originating subscribers. The directory of display devices includes means for associating the display address of the connected photo frame with the static IP address of the connected photo frame.

An exemplary directory of display devices is represented by table 1 below:

TABLE 1
Exemplary directory of display devices

| Display address | IMEI code | Static IP address |
|---|---|---|
| ABCD-1234-56 | 351557010202731 | 10.255.255.254 |
| EFGH-7891-23 | 351557010202732 | 10.255.255.253 |
| ZWYP-5468-87 | 351557010202733 | 10.255.255.252 |

In one embodiment, the display address is an encoding of the IMEI code using a predefined reversible encoding function. In this case, the “display address” column is not needed in the directory of display devices.

For example, the connected photo frame having the display address ABCD-5 1234-56 is the connected photo frame 8 shown in the communication network of FIG. 1.

The image-sharing server 1 also includes a module for managing originating subscriber accounts 15, an image-processing module 21 and a response-handling module 16, the functionalities of which will be described below.

The image-sharing server 1 communicates with the connected photo frame 8 and with the image storage server 13 over the virtual private network 12 via an IP communication interface 5.

The image storage server 13 includes an image storage module 6 in which images are stored at defined addresses. For example, these addresses are URLs. A storage processing module 11 of the image storage server 13 communicates with the image-sharing server 1 via a tunnel 20 in order to store an image transmitted by the image-sharing server 1. This tunnel is not needed if the two servers 1 and 13 are combined on a single platform. The storage processing module 11 may also transmit an image stored in the image storage module 6 to the connected photo frame 8.

The connected photo frame 8 is addressable by its static IP address, which is associated by the cellular radio access network with the IMSI subscriber number held in the non-volatile memory of a SIM card 18 present in a cellular communication module 17.

The connected photo frame 8 includes a cellular communication module 17 which allows the connected photo frame 8 to communicate in the virtual private network 12 via a cellular radio access network.

The connected photo frame 8 is provided with a image-loading module 10 for downloading an image, with an image storage module 9 for storing the image and with a screen 14 for displaying the images stored in the image storage module 9.

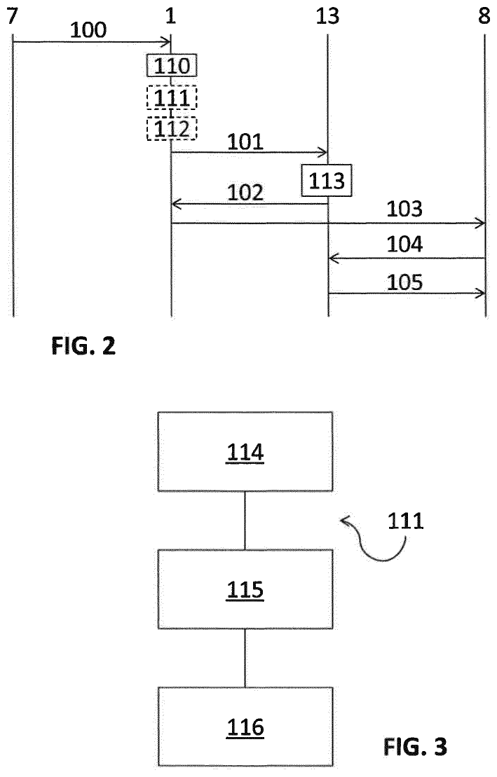

Now, a call diagram that may be implemented in the image-sharing system of FIG. 1 in order to display a new image on the connected photo frame 8 will be described with reference to FIG. 2.

The source device 7 sends an image display request 100 to the image-sharing server 1.

The image display request 100 may be sent to the image-sharing server 1 15 according to various protocols, for example an HTTPS or SMTP protocol.

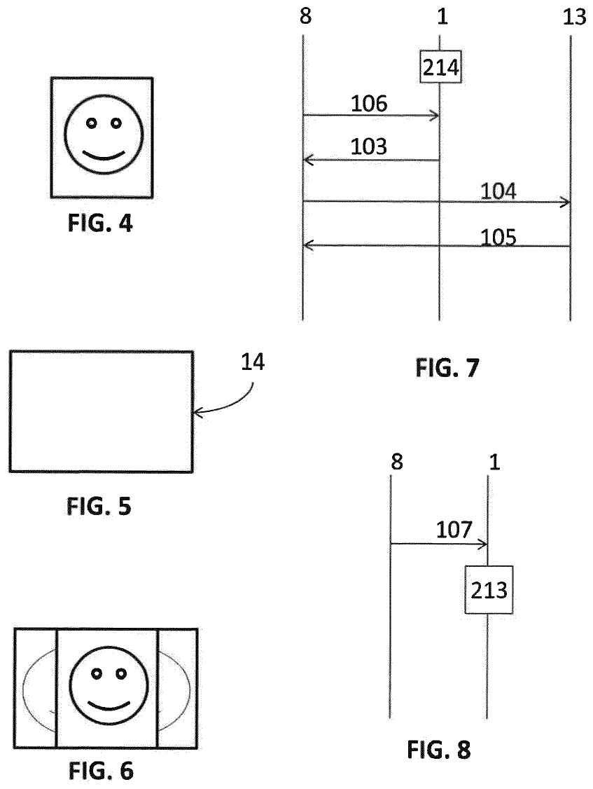

The image display request 100 includes the display address for the connected photo frame 8, for example ABCD-1234-56, and a new image to be transmitted and displayed, for example the image shown in FIG. 4.

The image-sharing server 1 receives the image display request 100 and processes it in its image-providing module 4 via a display request processing step 110 in which the static IP address associated with the connected photo frame 8 in the directory of image display devices is found using the display address, for example ABCD-1234-56.

Optionally, a second display request processing step 111 and a third display request processing step 112, which will be described below, may be carried out.

Next, the image-sharing server 1 sends a storage request 101 including the new image to the image storage server 13.

In step 113, the image storage server 13 stores the new image upon receipt of the request 101.

The image storage server 13 then sends a receipt message 102 including a storage address for the new image in the image storage server 13 to the image-sharing server 1. The storage address for the new image is generated by the image storage server 13.

The image-sharing server 1 then transmits, via a tunnel 20, an information message 103 to the static IP address of the connected photo frame 8 found previously in the directory of display devices.

The information message 103 includes the storage address for the new image, preferably a URL. The information message 103 may further include contextual information such as a caption associated with the new image, a date and an identifier of the originating subscriber sending the new image from the source device 7. The originating subscriber may send via a subscriber account, which will be described below.

Upon receiving the information message 103, the connected photo frame 8 downloads the new image, as represented by the reference numeral 105, by sending a download request 104 addressed to the storage address for the new image.

As soon as the new image has been downloaded, it is stored in the connected photo frame 8.

Various operations may be envisaged in the connected photo frame 8 after the new image has been received. Preferably, the new image is immediately displayed on the screen 14. Other operations may be envisaged. For example, these operations may comprise displaying a slideshow of the images stored in the connected photo frame 8, or displaying a mosaic of at least some of the stored images.

As illustrated above, the directory of display devices includes an entry including a connected photo frame identifier and the static IP address associated with the connected photo frame. In one preferred embodiment of the image-sharing server 1, the identifier of the connected photo frame is an encoding of the display address. For example, the encoding function used may be a bijective mathematical function.

In this case, the image-sharing server 1 may find the static IP address using the received display address by carrying out the second display request processing step 111 which is shown as sub-steps in FIG. 3.

The image-sharing server 1 includes a decoder module configured to implement these sub-steps. The decoding function corresponding to the encoding function is stored in the decoder module. In the case that the encoding function is a bijective function, then the decoding function is the inverse of the encoding function.
In sub-step 114, the decoder module receives the display address contained in the request 100.
In sub-step 115, the decoder module applies the decoding function to the display address in order to find the identifier of the connected photo frame,
In sub-step 116, the decoder module determines the static IP address on the basis of the identifier of the connected photo frame.

In one example, the identifier of the display device is an IMEI code, as shown in table 1.

The IMEI codes may be serial numbers of display device communication GSM chips which come one after the other sequentially, for example in the case that the display device communication GSM chips are ordered in series for the manufacture of the display devices in a factory. As such, an ill-intentioned person possessing an IMEI code of a display device could guess the IMEI codes of other display devices stored on the image-sharing server 1.

When the encoding function is used, the user is given only the display address which may be communicated by any medium, whether physical or digital. By virtue of the encoding function, the display addresses corresponding to successive IMEI codes do not come one after the other sequentially, as shown in table 1. Thus, the risk of an ill-intentioned person being able to guess the display address of another display device is decreased.

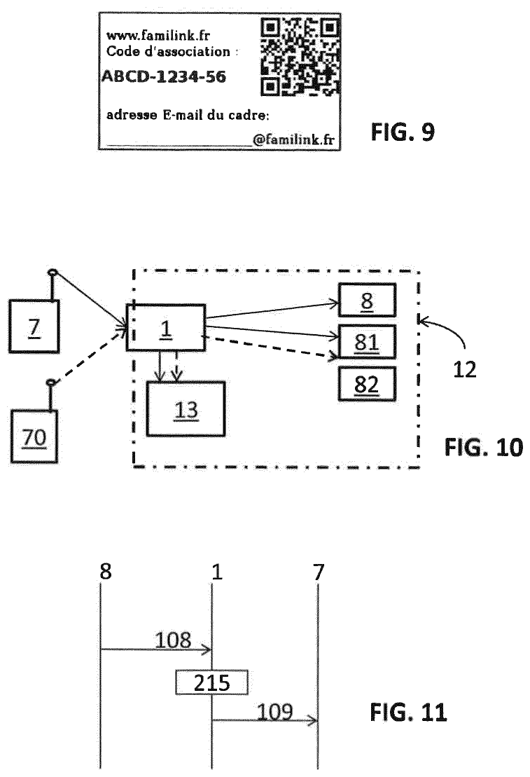

In one example, for the manufacture of connected photo frames or other display devices, a printer is directly programmed with an encoding function in order to print the display address on the user manual of a display device. An example of this printout is shown in FIG. 9. The display address shown is the string of characters ABCD-1234-56. The French term “code d′association” above the display address allows a reader to understand that the string of characters ABCD-1234-56 is a display address. Advantageously, to improve ease of use, in particular for elderly people, the display address is a string of characters featuring no ambiguous characters: no 0, 0, L, 1. The display address may also be contained in a QR code or a barcode.

In one refined embodiment, the image-sharing server 1 also includes an image-processing module 21 and the third display request processing step 112, which is an image-processing step, is implemented.

The image-processing module 21 includes image-processing functionalities in order to generate a reprocessed image on the basis of an image sent by a source device 7. The image sent to the image storage server 13 following this image processing is the reprocessed image.

The image processing may comprise functionalities for resizing, for filtering, for compression etc. In particular, the image-processing module 21 provides a functionality for automatically resizing the image to the shape of the screen 14. For example, this automatic resizing functionality may be set so as to add blurred borders on either side of the edges of an image when its dimensions do not correspond to the screen of the connected display device.

FIGS. 4 to 6 show this last functionality. FIG. 4 shows a new image sent by a source device 7 to the connected photo frame 8. For example, the new image is a digital photo taken in portrait format by a camera integrated in the source device 7, the source device 7 potentially being a smartphone. The connected photo frame 8 is intended for use in landscape format, as shown in FIG. 5. As such, portions of the 30 new image are duplicated and blurred, then added in the form of side borders on either side of the new image so as to generate an image reprocessed for the format of the screen 14. The result of this processing in shown in FIG. 6.

This resizing functionality may be implemented in other ways, for example to add top and/or bottom blurred borders to a new image in widescreen format to fit the connected photo frame used in landscape format. This functionality is also suitable for use with a connected photo frame in portrait format for resizing a new image in landscape format. If the screen 14 of the frame is square in shape, this functionality is suitable for adding blurred side borders to a new image in portrait format and for adding blurred top and/or bottom borders to a new image in landscape format.

The connected photo frame 8 is not always active. In particular, the connected photo frame 8 may set so as to go to sleep in the evening and to wake up in the morning, for example through the use of an activation module connected to a clock. The connected photo frame 8 may also include an on/off switch.

FIG. 7 is a call diagram illustrating the case in which the image-sharing server 1 sent the information message 103 to the connected photo frame 8 while the connected photo frame 8 was off or asleep.

The image-sharing server 1 then received no acknowledgement of receipt subsequent to its information message 103 via the TCP/IP stack. The TCP layer of the image-sharing server 1 sent a set number of RETRY attempts, each spaced apart by a set duration, and then sent a failure message.

Following this procedure, the image-sharing server 1 put the information message 103 on hold, as represented by the step of putting on hold 214.

When the connected photo frame 8 wakes up or is turned on, it sends a wakeup message 106 to signal this to the image-sharing server 1, which initiates a new operation of sending the information message 103 which was on hold, then the new image is downloaded as described above.

To form the directory of display devices stored in the image-sharing server 1, a number of procedures may be used, in particular when the connected photo frame is used for the first time. A first connection of a connected photo frame 8 to the image-sharing server 1 is shown in FIG. 8. When the connected photo frame 8 is used for the first time, the connected photo frame 8 is set up so as to send a register request 107. The image-sharing server 1 processes the content of this register request 107 in a registering step 213.

The register request 107 may include the IMEI code or another identifier of the connected photo frame 8 and the static IP address associated with the IMSI number stored in the SIM card.

The register requests 107 of each connected photo frame thus allow the directory of display devices to be formed.

For the originating subscriber using the source device 7, there is a user interface allowing the image display request 100 to be generated. The user interface may be supported by various means. For example, the user interface may be a web page supported by the image-sharing server 1. The user interface may also be supported by a dedicated application installed on the source device 7.

The browser of the source device 7 is configured to transfer, to the image-sharing server 1, the image selected from a memory of the source device 7 via the image display request 100.

For example, the user interface may include a form including an input field configured to receive a display address and an input field configured to receive an access path to a file so that the originating subscriber may select a connected photo frame by entering its display address and select a new image to be displayed on the connected photo frame.

The user interface may also include functionalities for modifying the new image before sending by the originating subscriber.

For example, the user interface may include a form including one or more fields configured to receive instructions to modify an image. Such instructions may be instructions to zoom, to apply a filter, to crop the image, etc.

The user interface may also include subscriber account personal management functionalities.

For example, the user interface may include a form including one or more fields configured to receive subscriber account information and a directory of display addresses.

Specifically, for ease of use, an originating subscriber may create an address book of connected photo frames associated with their subscriber account.

To this end, the functionalities of the module for managing originating subscriber accounts 15 of the image-sharing server 1 include in particular creating a subscriber account and saving display address(es) in association with the subscriber account in a directory of originating subscriber accounts.

An exemplary directory of originating subscriber accounts is represented by table 2 below:

TABLE 2
Exemplary directory of originating subscriber accounts

| Contact information for | Recipient display | personalized name of |
|---|---|---|
| the originating subscriber | address(es) | connected photo frame |
| Pierre, | ABCD-1234-56 | Dad |
| pierre@gmail.com, | EFGH-7891-23 | Grandma |
| 0666666666 | | |
| Paul, paul@sfr.fr, | EFGH-7891-23 | Mom |
| 0777777777 | | |
| Jacques, | ZWYP-5468-87 | Gertrude |
| 0677777777 | | |

Preferably, an originating subscriber may enter any chosen string of characters as the personalized name of the connected photo frame. For example, the following string of characters: “Grandma”, is associated with the display address EFGH-7891-23 in Pierre's subscriber account, Pierre being the grandson of the owner of the connected photo frame associated with the display address EFGH-7891-23. The following string of characters: “Mom”, is associated with the same display address EFGH-7891-23, but in Paul's subscriber account, Paul being the grandson of the owner of the connected photo frame associated with the display address EFGH-7891-23.

The directory of originating subscriber accounts may be formed as described below.

A recipient user who owns a connected photo frame communicates access information for their connected photo frame to a person who wishes to send photos. For example, this person is the one who gave the connected photo frame to the recipient user.

The access information for a connected photo frame includes the display address for the connected photo frame. The access information for a connected photo frame may further include addresses for access to a web portal for downloading an application and/or to a web page allowing access to the user interface described above.

With reference to FIG. 9, an example of access information for the connected photo frame 8 accessible from its user manual is shown.

The access information includes a QR code and a URL address, for example: www.familink.fr, the QR code and the URL address leading to the same web portal so that the person who wishes to send photos may access the user interface. Advantageously, if the source device 7 has an integrated camera, the source device 7 may scan the QR code to access the web portal.

This person may then create a subscriber account. To this end, they are invited to choose their subscriber identifier, for example “Pierre”, to enter one or more display address(es), for example “ABCD-1234-56” and “EFGH-7891-23”, and to choose a personalized name for each connected photo frame, for example “Dad” and “Grandma”.

Thus, a plurality of connected photo frames may be associated with the same subscriber account, and a plurality of originating subscribers may send images to the same connected photo frame.

With reference to FIG. 10, the source device 7 belonging to Pierre and the source device 70 belonging to Paul are shown in communication with the connected photo frame 8 having the display address “ABCD-1234-56” and the connected photo frame 81 having the display address “EFGH-7891-23”.

The image display request 100 sent by the source device 7 may include two display addresses for the same image. For this, the originating subscriber selects a plurality of display addresses from the address book of their subscriber account, via the user interface.

As represented by the solid arrows, the source device 7 sends the same digital photo to the two connected photo frames 8 and 81. As represented by the dashed arrows, the source device 70 addresses an image to the connected photo frame 8.

Although only three connected photo frames 8, 81 and 82 are shown in the virtual private network 12, a plurality of connected photo frames of any number may be envisaged.

Although the communication between the source device 7 and the connected photo frame 8 or other display device is essentially asymmetric, the connected photo frame 8 or other display device may include a functionality for sending a response via a response-handling module 16 of the image-sharing server 1.

The functionalities of the response-handling module 16 of the image-sharing server 1 include in particular the possibility, for the user of the connected photo frame, of sending a response to the originating subscriber after receiving a new image. This response may be triggered by an action by the recipient user. For example, this action may be pressing a button, for example a button via a touchscreen. In one example, the button is a button set up to, in response to being pressed, send a notification to the source device 7 via the application, or an email to the contact addresses entered into the subscriber account.

The content of this notification and/or of this email may be prerecorded for ease of use, in order to minimize the actions to be performed on the part of the recipient user.

For example, this content is an expression of thanks, a “like”, or a request to order a printed version of the received new image.

The content of this notification and/or of this email may also be modified by the recipient user, for example via a keyboard, for example a touch keyboard.

FIG. 11 illustrates the transmission of a response message 108 via the communication network of FIG. 1.

The connected photo frame 8 experiences one of the actions by the user described above, which prompts the sending of the response message 108. The response message 108 includes an identifier of the received new image and/or an identifier of the originating subscriber who sent this received new image.

The image-sharing server 1 finds, in a step of finding a subscriber address 215, contact information for the originating subscriber who sent this new received image. This contact information is stored in the directory of originating subscriber accounts such as illustrated by table 2. This contact information may be found using the identifier of the received new image or the identifier of the originating subscriber. For example, this contact information may include an address for the source device, an email address, a telephone number and an identifier of the originating subscriber.

The image-sharing server 1 then addresses this notification and/or this email 109 to the source device 7 if its address is present in the directory of originating subscriber accounts.

Although the invention has been described in connection with a number of particular embodiments, it is obvious that it is in no way limited thereby and that it comprises all the technical equivalents of the means described and the combinations thereof where these fall within the scope of the invention.

In particular, although the invention has been described in conjunction with still images, the image-sharing server, the image storage server and the connected photo frame could also be used to share videos.

Some of the elements shown, in particular the image-sharing and image storage servers and the various modules, may be embodied in various forms, in a unitary or distributed manner, by means of hardware and/or software components. Hardware components that can be used are application-specific integrated circuits (ASICs), field-programmable gate arrays (FPGAs) or microprocessors. Software components may be written in various programming languages, for example C, C++, Java or VHDL. This list is not exhaustive.

The use of the verb “have”, “comprise” or “include” and of the conjugated forms thereof does not exclude the presence of elements or steps other than those set out in a claim. The use of the indefinite article “a/an” or “one” for an element or a step does not, unless stated otherwise, rule out the presence of a plurality of such elements or steps.

In the claims, any reference sign between parentheses should not be interpreted as limiting the claim.

1.-17. (canceled)

18. A connected photo frame including:
a cellular communication module which allows said connected photo frame to communicate in a virtual private network and comprising a SIM card,
a non-volatile memory in the SIM card storing an IMSI identifier corresponding to a static IP address configured to belong to said virtual private network, to allow said connected photo frame to be addressed,
an image storage module configured to store images,
a screen configured to display the images stored in the image storage module,
an image-loading module configured to:
receive, from an image-sharing server through the virtual private network, an information message including a storage address for a new image in an image storage server of said virtual private network,
send a load request destined for the image storage server through the virtual private network in response to receiving the information message, the load request including the address for the new image,
receive the new image from the image storage server through the virtual private network,
store the new image in the image storage module.

19. The connected photo frame as claimed in claim 18, further including a cellular communication module for communicating with the image-sharing server via a cellular network.

20. The connected photo frame as claimed in claim 18, wherein the SIM card is an M2M SIM card.

21. The connected photo frame as claimed in claim 18, wherein the image-loading module is configured to, in response to receiving the new image, immediately display the new image on the screen.

22. The connected photo frame as claimed in claim 18, further including a response interface configured to, in response to an action by a recipient user on the connected photo frame, send a response message to the image-sharing server, the response message including an identifier of an image with which the response is associated or an originating subscriber identifier of the originator of an image with which the response is associated.

23. An image-sharing method including
providing a connected photo frame as claimed in claim 18;
receiving, from a smartphone, an image display request including a display address and an image,
determining whether the display address is associated with the connected photo frame having a private static IP address,
transmitting, to an image storage server, a storage request including the image,
receiving, from the image storage server, a receipt message), the receipt message including a storage address for the image in the image storage server, and
through a virtual private network, transmitting, to a static IP address associated with the connected photo frame, an information message including the storage address for the image.
receiving, at a static IP address configured to belong to a virtual private network, from an image-sharing server through the virtual private network, an information message including a storage address for a new image in the image storage server,
sending a load request destined for the image storage server through the virtual private network in response to receiving the information message, the load request including the address for the new image,
receiving the new image from the image storage server through the virtual private network, and
storing the new image in an image storage module and/or displaying the new image on a screen.

24. The method as claimed in claim 23, further comprising a step consisting in selecting a plurality of display addresses from an address book.

25. An image-sharing system suitable for implementing the method as claimed in claim 24, comprising:
a set of at least one connected photo frame, connected to a virtual private network;
an image-sharing server including:
a receiver interface configured to receive, from said set of at least one smartphone, an image display request to display an image on a set of at least one connected photo frame having a private static IP address, the image display request including one or more display addresses and an image,
a data storage module storing a directory of connected photo frames, said directory including static IP addresses in the virtual private network, said static IP addresses being respectively associated with a plurality of connected photo frames,
a module for providing images, which is closed, addressable and configured to, in response to receiving the image display request:
determine whether the display address corresponds to a static IP address present in the directory of connected photo frames and associated with at least one connected photo frame,
transmit, to an image storage server, a storage request including the image,
receive, from the image storage server, a receipt message), the receipt message) including a storage address for the image in the image storage server, and
through the virtual private network, transmit, to the static IP address associated with the set of at least one connected photo frame, an information message including the storage address for the image.

26. The system as claimed in claim 25, wherein the information message is transmitted in response to receiving said receipt message.

27. The system as claimed in claim 25, wherein the directory of connected photo frames includes associations between the display addresses and the static IP addresses.

28. The system as claimed in claim 27, wherein the directory of connected photo frames includes an entry for each connected photo frame, said entry including a connected photo frame identifier and a static IP address associated with the connected photo frame, and wherein the connected photo frame identifier is associated through encoding with a display address, the image-sharing server including a decoder module configured to decode the display address received in the image display request in order to find a connected photo frame identifier in the directory of connected photo frames.

29. The system as claimed in claim 28, wherein the connected photo frame identifier is an IMEI number of the connected photo frame.

30. The system as claimed in claim 25, wherein the storage address for the image is a URL.

31. The system as claimed in claim 25, further including an image-processing module configured to process the image received in the image display request so as to generate a reprocessed image, the image sent to the image storage server being the reprocessed image.

32. The system as claimed in claim 31, wherein the directory of display devices further includes screen size settings of the connected photo frame, and the image-processing module is configured to apply, to the image, processing for resizing according to the screen size settings.

33. The system as claimed in claim 25, wherein the image-sharing server further includes a subscriber directory stored in the data storage module and a response-handling module configured to:
receive a response message, the response message including an image identifier or an originating subscriber identifier,
determine, using the subscriber directory, whether the image identifier or the originating subscriber identifier is associated with contact information for an originating sub scriber,
perform a response information action according to the contact information for the originating subscriber.

34. The system as claimed in claim 25, wherein the display address is a first display address and the static IP address is a first static IP address, the connected photo frame is a first connected photo frame, the image display request further including a second display address, the module for providing images being further configured to, in response to receiving the transmission message,
determine whether the second display address corresponds to a second static IP address present in the directory of display devices and associated with a second connected photo frame,
through the virtual private network, transmit, to the address associated with the second connected photo frame, the information message including the storage address for the image.
